(19) United States
(12) Patent Application Publication
(10) Pub. No.: US 2016/0139857 A1
(43) Pub. Date: May 19, 2016

(54) PRINT APPARATUS, METHOD OF CONTROLLING A PRINT APPARATUS, AND A NON-TRANSITORY COMPUTER-READABLE STORAGE MEDIUM

(71) Applicant: CANON KABUSHIKI KAISHA, Tokyo (JP)

(72) Inventor: Takashi Kuroda, Tokyo (JP)

(21) Appl. No.: 14/927,074

(22) Filed: Oct. 29, 2015

(30) Foreign Application Priority Data
Nov. 13, 2014 (JP) 2014-231047

(51) Int. Cl. G06F 3/12; G06K 15/00

(52) U.S. Cl. CPC G06F 3/1204; G06K 15/403; G06F 3/1273; G06F 3/1286; G06F 3/1287

(57) ABSTRACT

A print unit configured to print an image on a sheet; an operation unit configured to accept an instruction from a user; a control unit configured to cause printing by the print unit to stop based on acceptance of a print stop instruction via the operation unit, and to cause printing by the print unit to resume based on acceptance of a print resume instruction via the operation unit; and an acquisition unit configured to acquire a number of copies printed from when the print unit started printing to when printing is stopped by the control unit are comprised. The control unit, after causing printing by the print unit to resume, causes printing by the print unit to stop based on the number of copies that the acquisition unit acquired.

### BACKGROUND OF THE INVENTION

1. Field of the Invention

The present invention is related to a technique for discharging and stacking sheets on a sheet bundle stacking unit.

2. Description of the Related Art

There are conventional image forming apparatuses that fold a sheet bundle after binding the sheet bundle on which images are formed, and discharge and stack the folded sheet bundle from a discharging port to a sheet bundle stacking unit arranged at a lower side of the discharging port. Also there are those in which in the sheet bundle stacking unit a stacking stopper for receiving and stopping a downstream side end of a sheet bundle discharged to a sheet bundle stacking unit is provided (Japanese Patent Laid-Open No. H11-193162).

Also, there are those that fold in two a sheet bundle on which images are formed without binding, and that discharge and stack the folded sheet bundle from the discharging port to a sheet bundle stacking unit arranged at a lower side of the discharging port.

When a large number of sheet bundles are stacked on such a sheet bundle stacking unit, the height of the sheet bundles becomes correspondingly larger. When the height of the sheet bundles exceeds the height of the stacking stopper, the sheet bundle can no longer be received and stopped. There are those in which, in order to prevent this, discharging of sheet bundles is temporarily stopped when number of stacked copies that is defined in advance are stacked, and discharging of continuing sheet bundles is performed having waited for the stacked sheet bundles to be removed by the user.

Also, an arrangement can be considered in which in order to stack more sheet bundles, the sheet bundles are input into a box arranged on a downstream side of the stacking unit as are without receiving and stopping them on the stacking unit by the stacking stopper (such an arrangement is called a “stacking through mode”). For example, a configuration in which it is possible to knock down the stacking stopper physically so that the function of the stacking stopper receiving and stopping a sheet bundle is not carried out. In other words, a configuration by which it is possible to selectively perform a physical operation of knocking down the stacking stopper (stacking through mode), and returning it (normal stacking mode) in accordance with the will of the user is taken. Then, in the normal stacking mode is set, sheet bundles are stacked by receiving and stopping by the stacking stopper on the sheet bundle stacking unit, but in cases where many copies are discharged, discharged sheet bundles are stored in a box by a user setting the stacking through mode by knocking down the stacking stopper having arranged a box on their own, for example. By controlling so as to not to perform, in the stacking through mode, a restriction of discharging of sheet bundles for up until a number of stacked copies defined in advance, and using an appropriately sized box, it becomes possible to store more sheet bundles than when stacking on the stacking unit. In such a case, there is the additional convenient aspect that discharged sheet bundle groups can be carried as are in the box.

However, in a case where the output sheet bundles cannot fit into a single box, it is necessary to exchange boxes part way through, and it is necessary to temporarily stop the print processing in order to exchange the boxes. When a large number of prints are performed, the exchange of boxes must be performed multiple times, and the work to temporarily stop the print processing each time is burdensome.

### SUMMARY OF THE INVENTION

The present invention was conceived in view of these kinds of problems, and provides a technique for eliminating the need for a user to perform burdensome work of temporarily stopping print processing every time the exchange of boxes is performed when performing a large number of prints.

According to the first aspect of the present invention, there is provided a print apparatus, comprises a print unit configured to print an image on a sheet; an operation unit configured to accept an instruction from a user; a control unit configured to cause printing by the print unit to stop based on acceptance of a print stop instruction via the operation unit, and to cause printing by the print unit to resume based on acceptance of a print resume instruction via the operation unit; and an acquisition unit configured to acquire a number of copies printed from when the print unit started printing to when printing is stopped by the control unit, wherein the control unit, after causing printing by the print unit to resume, causes printing by the print unit to stop based on the number of copies that the acquisition unit acquired.

According to the second aspect of the present invention, there is provided a method of controlling a print apparatus that comprises a print unit configured to print an image on a sheet and an operation unit configured to accept an instruction from a user, the method comprising: causing printing by the print unit to stop based on acceptance of a print stop instruction via the operation unit, and causing printing by the print unit to resume based on acceptance of a print resume instruction via the operation unit; and acquiring a number of copies printed from when the print unit started printing to when printing is caused to stop, wherein after printing by the print unit is caused to resume, printing by the print unit is caused to stop based on the acquired number of copies.

According to the third aspect of the present invention, there is provided a non-transitory computer-readable storage medium storing a computer program for causing a computer of a print apparatus, the print apparatus comprises a print unit configured to print an image on a sheet and an operation unit configured to accept an instruction from a user, to function as a control unit configured to cause printing by the print unit to stop based on acceptance of a print stop instruction via the operation unit, and to cause printing by the print unit to resume based on acceptance of a print resume instruction via the operation unit; and an acquisition unit configured to acquire a number of copies printed from when the print unit started printing to when printing is stopped by the control unit, wherein the control unit, after causing printing by the print unit to resume, causes printing by the print unit to stop based on the number of copies that the acquisition unit acquired.

Further features of the present invention will become apparent from the following description of exemplary embodiments (with reference to the attached drawings).

### BRIEF DESCRIPTION OF THE DRAWINGS

FIG. 1 is a view for illustrating an example configuration of an image forming system.

FIG. 2 is a block diagram for illustrating an example configuration of an image forming apparatus.

FIG. 3 is a view for illustrating an example configuration of a printer unit 202.

FIG. 4 is a view for illustrating an example configuration of a finisher unit 205.

FIGS. 5A and 5B are views for illustrating an example of the ability of a stacking stopper 814 to move using.

FIGS. 6A and 6B are views for illustrating example configurations of an operation unit 203.

FIGS. 7A and 7B are flowcharts for illustrating an operation of an image forming apparatus 101.

FIG. 8A is a view for illustrating a display example of a GUI 901.

FIG. 8B is a view for illustrating a display example of a GUI 905.

FIG. 8C is a view for illustrating a display example of a GUI 911.

FIG. 9 is a view for illustrating a display example of a GUI 921.

FIGS. 10A and 10B are views for illustrating display examples of a GUI.

FIGS. 11A and 11B are flowcharts for illustrating an operation of the image forming apparatus 101.

### DESCRIPTION OF THE EMBODIMENTS

Embodiments of the present invention will be described hereinafter in detail, with reference to the accompanying drawings. Note that embodiments described below merely illustrate examples of specifically implementing the present invention, and are only specific embodiments of a configuration defined in the scope of the claims.

### First Embodiment

Firstly, an explanation is given for an example configuration of an image forming system according to the present embodiment using FIG. 1. As shown in FIG. 1, an image forming system 100 according to the present embodiment is comprised of an image forming apparatus 101 and a computer terminal 102; the image forming apparatus 101 and the computer terminal 102 are connected to a network 103 such as a LAN or the Internet. With this, the image forming apparatus 101 and the computer terminal 102 are capable of a data communication with each other through the network 103.

The image forming apparatus 101 is an apparatus comprising a scanner function with which the image forming apparatus 101 can read information recorded on a recording medium (hereinafter referred to as a sheet) such as paper as an image, and a print function with which the image forming apparatus 101 records an image or text on a sheet. Note that for the scanner function and the print function, implementation may be in color/monochrome.

The computer terminal 102 is an information processing apparatus such as a PC (personal computer), a cellular phone, a tablet terminal device, or the like, and is a device capable of instructing a printing of a printing target by transmitting data of the printing target such as an image or a document to the image forming apparatus 101, or instructing a printing based on data which the image forming apparatus 101 is caused to hold.

Note, the configuration of the system shown in FIG. 1 is merely one example. For example, neither the number of the image forming apparatus 101 and the number of the computer terminal 102 are limited to one, and the network 103 may be configured by two or more types of networks.

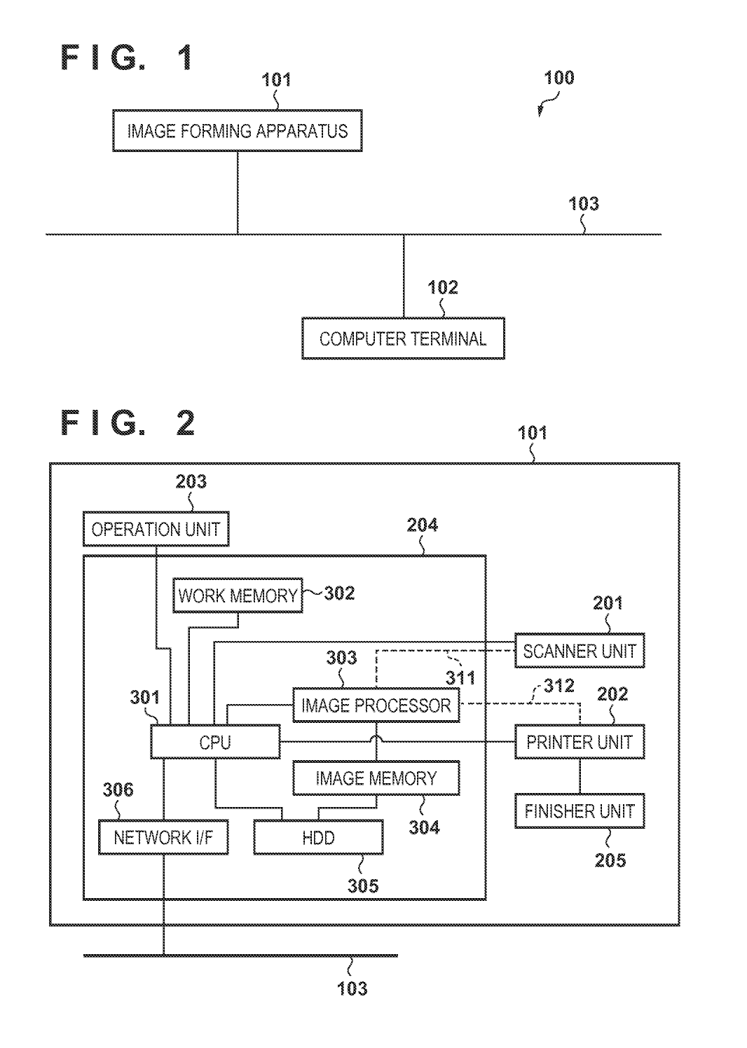

Next, an explanation is given for an example configuration of the image forming apparatus 101 using a block diagram in FIG. 2.

An operation unit 203 comprises a touch panel screen configured by a display screen for displaying various information such as a GUI (Graphical User Interface) and a touch panel for detecting a touch position on the display screen, hard keys, or the like.

A scanner unit 201 is, as is known, for reading information recorded on a sheet as an image, and the image read by the scanner unit 201 is transmitted to a controller 204.

A printer unit 202 is, as is known, for printing an image, text or the like on a sheet based on data supplied from the controller 204, and discharging the sheet. A finisher unit 205 is connected to the printer unit 202 (more strictly on a downstream side of the printer unit 202).

The finisher unit 205 is for applying one or more sheet process (post-processing such as stapling) to a sheet discharged from the printer unit 202, and for stacking a sheet discharged from the printer unit 202 or a sheet for which sheet processing is already performed.

The controller 204 performs control of operation of the image forming apparatus 101 on the whole, and executes or controls each process explained later as being performed by the image forming apparatus 101.

The image forming apparatus 101 having the above configuration is capable of realizing a copy function in which, for example, the printer unit 202 prints an image read from a sheet by the scanner unit 201 on a sheet.

Also, in the image forming system 100 according to the present embodiment, the computer terminal 102 is capable of transmitting a document generated in the computer terminal 102 to the controller 204 through the network 103 as page description language (PDL) data. The controller 204 extracts the received PDL data into an image in a printable format. Also, because various setting information such as an operation setting for when printing is transmitted from the computer terminal 102, the controller 204 receives the setting information. Then the controller 204 controls the printer unit 202 to print an image or text on a sheet based on the extracted image and this setting information. In this way, the image forming system 100 according to the present embodiment is capable of realizing a PDL print function and a network printer function for causing the image forming apparatus 101 to perform a printing based on PDL data transmitted from the computer terminal 102 through the network 103.

[Configuration of the Controller 204]

Next, an explanation is given for an example configuration of the controller 204 using FIG. 2.

A CPU 301 performs operation control of each unit comprised in the image forming apparatus 101 by executing processing using a computer program or data stored on a work memory 302, and executes each process which is described later as performed by the controller 204.

The work memory 302 comprises an area for storing data received from the computer terminal 102 through a network I/F 306 and an area for storing a computer program or data loaded from an HDD (hard disk drive) 305. Furthermore, the work memory 302 comprises an area used upon execution of various processing by the CPU 301. In this way, the work memory 302 is capable of providing various areas appropriately.

An image processor 303 realizes various image processing based on control by the CPU 301. The CPU 301 controls the image processor 303, applies appropriate image processing to an image read by the scanner unit 201, and stores the image processed image in the HDD 305 via an image memory 304, for example. In a case where the image processed image is printed, the CPU 301 reads the image processed image from the HDD 305, and applies appropriate image processing to the read out image using the image processor 303, and then sends to the printer unit 202.

Also, the CPU 301 stores PDL data received from the computer terminal 102 through the network I/F 306 in the HDD 305, and then controls the image processor 303 to extract the PDL data into an image on the image memory 304, and stores the extracted image in the HDD 305. Furthermore, the CPU 301 also stores setting information of a print attribute the extracted image in the HDD 305. The setting information of the print attribute comprises of information such as a size of the extracted image, settings for when printing that are included in the PDL data, or the like. In a case where the image processed extracted image is printed, the CPU 301 reads the extracted image from the HDD 305, and applies appropriate image processing to the read out image using the image processor 303, and then sends it to the printer unit 202.

Note, explanation is given for an example where the printer unit 202 is caused to print an image acquired from the scanner unit 201 and an image based on PDL data acquired from the computer terminal 102, but an image to be printed by the printer unit 202 may be an image acquired in any form. This is the same even for printing targets other than images (for example, documents). In a case where a printing target such as an image is outputted to the printer unit 202, setting information required for printing and discharging such as information for identifying an output destination tray is also outputted.

A computer program, data, various setting data, or the like, for causing the CPU 301 to execute each process described later which is performed by the controller 204, are stored on the HDD 305. The computer programs and the data saved in the HDD 305 are loaded to the work memory 302 as appropriate according to control by the CPU 301, and are targets of processing by the CPU 301. Note that values of variables used for the following explanation may be managed in the work memory 302, or may be managed in the HDD 305.

[Configuration of the Printer Unit 202]

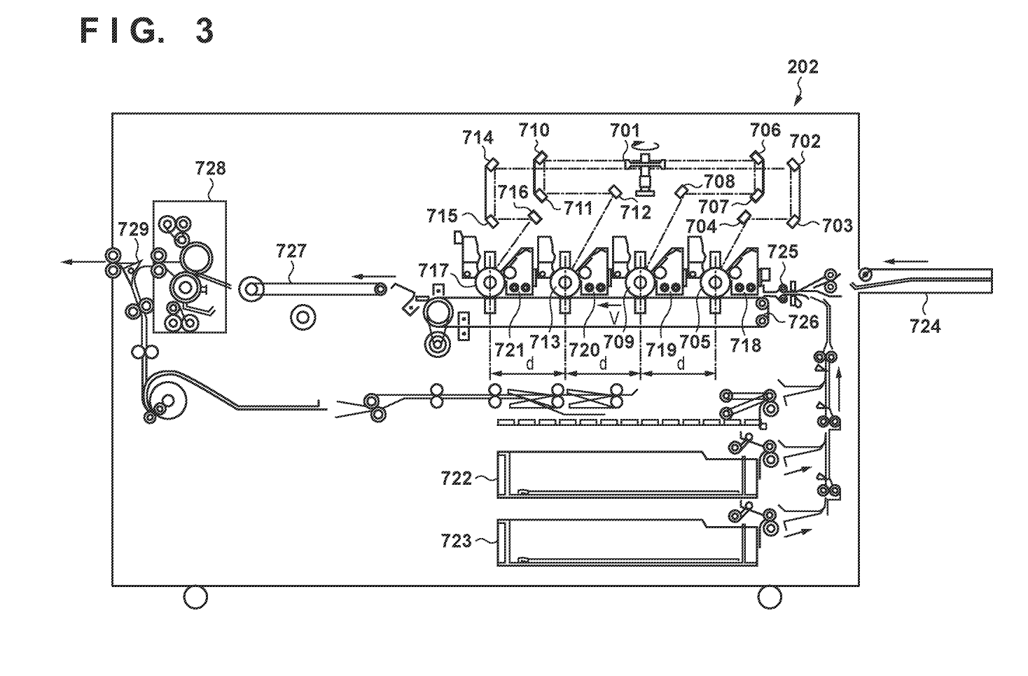

Next, an explanation is given for an example configuration of the printer unit 202 using FIG. 3. A polygon mirror 701 receives four laser beams emitted from a semiconductor laser driving unit. One of the laser beams scans a photosensitive drum 705 passing mirrors 702, 703 and 704. Another one of the laser beams scans a photosensitive drum 709 passing mirrors 706, 707 and 708. Furthermore, another one of the laser beams scans a photosensitive drum 713 passing mirrors 710, 711 and 712. Furthermore, another one of the laser beams scans a photosensitive drum 717 passing mirrors 714, 715 and 716.

Meanwhile, a developer 718 supplies a yellow (Y) toner, and in accordance with scanning of the laser beam, a latent image that is formed on the photosensitive drum 705 is developed and a yellow toner image is formed. A developer 719 supplies a magenta (M) toner, and in accordance with scanning of the laser beam, a latent image that is formed on the photosensitive drum 709 is developed and a magenta toner image is formed. A developer 720 supplies a cyan (C) toner, and in accordance with scanning of the laser beam, a latent image that is formed on the photosensitive drum 713 is developed and a cyan toner image is formed. Furthermore, a developer 721 supplies a black (K) toner, and in accordance with scanning of the laser beam, a latent image that is formed on the photosensitive drum 717 is developed and a black toner image is formed. The toner images of the above described four colors (Y, M, C, K) are transferred to a sheet and an output image of full color can be obtained.

A sheet fed by either of sheet cassettes 722 and 723 or a manual feed tray 724 passes through a registration roller 725, is pulled in by a transfer belt 726, and conveyed. A toner of each color is developed beforehand on the photosensitive drums 705, 709, 713 and 717 in synchronization with a timing of sheet feeding, and toner is transferred to a sheet in conjunction with conveyance of the sheet. A sheet to which a toner of each color is transferred is separated from the transfer belt 726 and conveyed to a fixing unit 728 by a conveyer belt 727. The toner is fixed to the sheet in the fixing unit 728. A sheet that leaves the fixing unit 728 is first guided in a downward direction by a flapper 729, and after a trailing edge of the sheet detaches from the flapper 729, a switchback is performed and the sheet is discharged. With this, the sheet is discharged in a face-down state, and when printing sequentially from the first page, the correct page order is achieved.

Note that the four photosensitive drums 705, 709, 713 and 717 are arranged at equal intervals of a distance d, and the sheet is conveyed with fixed velocity v by the transfer belt 726. The polygon mirror 701 and a semiconductor laser are driven such that a toner image is formed on a photosensitive drum in synchronization with a timing according to these kinds of positional relationships and the conveying speed.

[Configuration of the Finisher Unit 205]

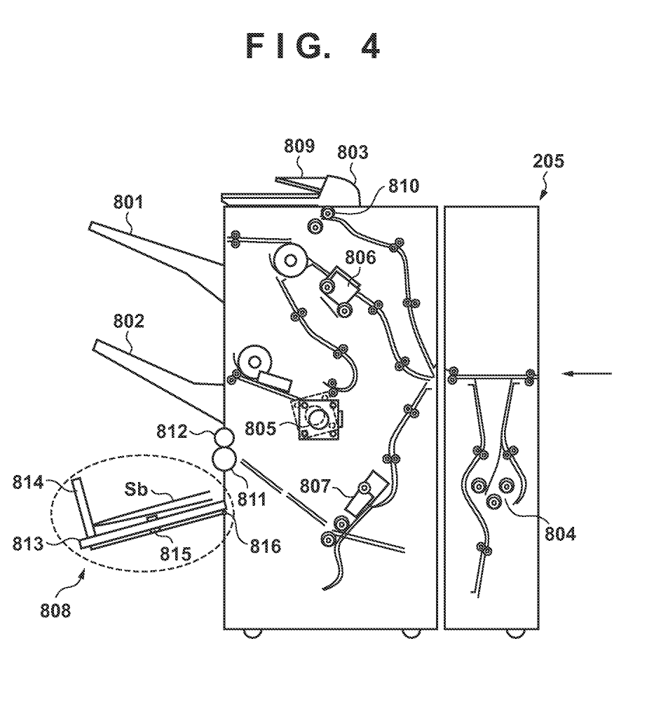

Next, an explanation is given for an example configuration of the finisher unit 205 using FIG. 4. The sheet discharged via the fixing unit 728 of the printer unit 202 enters the finisher unit 205. The finisher unit 205 comprises an escape tray 801, a stack tray 802, and a stacking tray 813 of a sheet stacking unit 808, and the tray that is the discharging destination is switched in response to the type of a job, the number of sheets to be discharged, or the like. Note, “the stacking tray 813 of the sheet stacking unit 808” is called a saddle tray.

Furthermore, in the case of discharging to the stack tray 802, it is possible for sheets to be accumulated for each job prior to the sheets being discharged, and for a stapler 805 to perform stapling immediately before discharging. Also, before reaching the above described two trays there is also a z-folding device 804 for folding a paper in a Z shape, and a puncher 806 for performing hole punching of two holes (or three holes) for a file, and respective processing is performed according to the type of the job.

Furthermore, a saddle stitcher 807 binds two places on the central portion of a plurality of sheets (a sheet bundle), and then folds the sheet bundle by causing the central portion of the sheet bundle to be pinched by a roller, and thereby performs processing for generating a booklet such as a weekly magazine or a pamphlet. Such a booklet is called a “saddle stitching”. The sheet bundle bound by the saddle stitcher 807 passes between a discharging roller 811 and a discharging skid 812, and is discharged toward the stacking tray 813 of the sheet stacking unit 808.

The sheet stacking unit 808 comprises of the stacking tray 813, a stacking stopper 814, a bundle detection sensor 815, a stacking mode detection sensor 816, or the like, and is arranged near the discharging roller 811 and the discharging skid 812 of the finisher unit 205. A sheet or a sheet bundle passes between the discharging roller 811 and the discharging skid 812, and is discharged toward the stacking tray 813 (saddle tray) of the sheet stacking unit 808.

The stacking tray 813 is fixed to the finisher unit 205 and arranged so that a leading edge side falls lower than a side of the discharging roller 811. For this reason, a sheet bundle Sb discharged to the stacking tray 813 moves to the leading edge side on the stacking tray 813.

The stacking stopper 814 is a stopper for receiving and stopping a sheet, and a stopper which can move between a state in which the sheet bundle Sb which has moved to the leading edge side on the stacking tray 813 can be received and stopped and a state in which the sheet bundle Sb which has moved to the leading edge side on the stacking tray 813 cannot be received and stopped. In a case of the state where it is possible to receive and stop, that is detected by the stacking mode detection sensor 816 and notification thereof is made to the CPU 301 as a normal stacking mode, in a case of the state where it is not possible to receive and stop, that is detected by the stacking mode detection sensor 816 and notification thereof is made to the CPU 301 as a stacking through mode.

The bundle detection sensor 815 is attached to the stacking stopper 814, and is a sensor that operates during the normal stacking mode, and is a sensor for detecting whether or not a sheet bundle Sb exists on the stacking tray 813.

[Normal Stacking Mode and Stacking Through Mode]

As described above, the stacking stopper 814 is a stopper which can move between a state in which it can receive and stop the sheet bundle Sb which has moved to the leading edge side on the stacking tray 813, and a state in which it cannot receive and stop the sheet bundle Sb which has moved to the leading edge side on the stacking tray 813; if knocked down to an underside by an operation of a user, it enters “a state in which it cannot receive and stop the sheet bundle Sb”, and if pulled up it enters “a state in which it can receive and stop the sheet bundle Sb”.

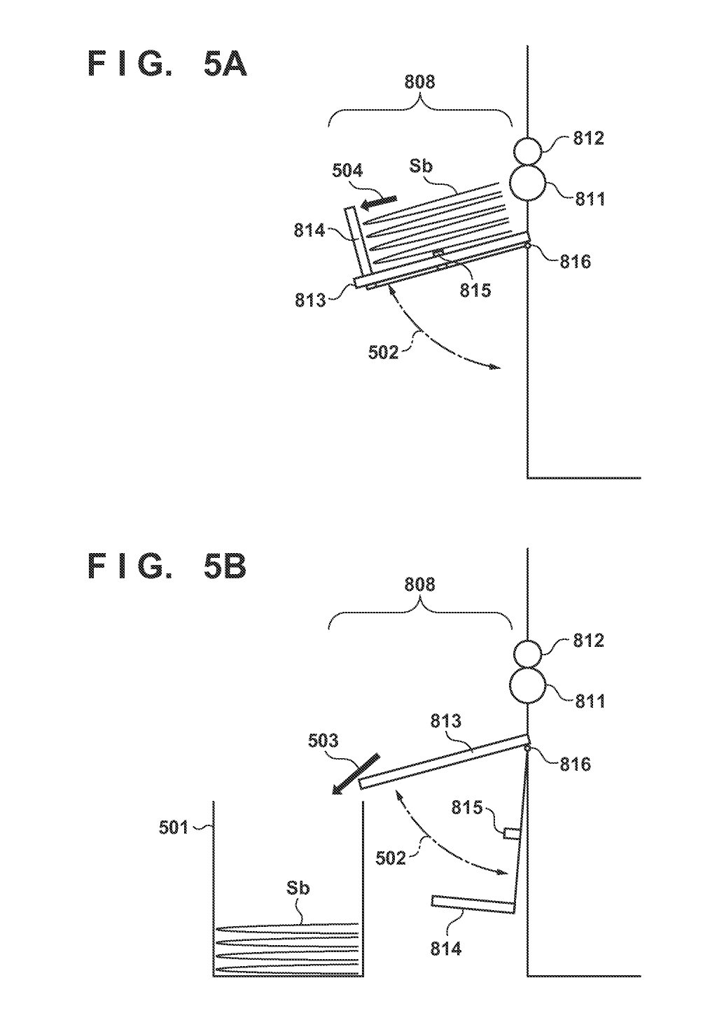

An explanation is given for an example of the ability of the stacking stopper 814 to move using FIGS. 5A and 5B. As shown in FIGS. 5A and 5B, the stacking stopper 814 is arranged to be able to rotate bidirectionally as shown by a dashed-dotted line arrow 502 around an axis in the vicinity of a root where the stacking tray 813 is attached to the finisher unit 205 (a position around the stacking mode detection sensor 816 in FIGS. 5A and 5B).

FIG. 5A shows a state where the stacking stopper 814 rotates to a predetermined position in a clockwise direction (the stacking stopper 814 and the bundle detection sensor 815 are partially-fixed to positions at which they protrude through the upper surface of the stacking tray 813); in this state, a sheet bundle Sb discharged through the discharging roller 811 and the discharging skid 812 of the finisher unit 205 moves onto the stacking tray 813 as shown by an arrow symbol 504, and its leading end portion is received and stopped by the stacking stopper 814. Accordingly, the sheet bundle Sb discharged to the stacking tray 813 is stacked on the stacking tray 813 and its leading end is aligned. Also, because the bundle detection sensor 815 is attached to the stacking stopper 814 as described above, it is possible for the bundle detection sensor 815 to detect the existence of the sheet bundle Sb stacked on the stacking tray 813 in this state. Also, when the stacking mode detection sensor 816 detects a state where the stacking stopper 814 is rotated to a predetermined position in a clockwise direction (a status in FIG. 5A), the stacking mode detection sensor 816 determines that the normal stacking mode is set and notifies the CPU 301 of that.

On the other hand, a state in which the stacking stopper 814 is rotated to a predetermined position in a counterclockwise direction is illustrated in FIG. 5B; the leading end portion of a sheet bundle Sb discharged through the discharging roller 811 and the discharging skid 812 of the finisher unit 205 is not received and stopped by the stacking stopper 814 in this state, and as a result the sheet bundle Sb slips off in the direction shown by an arrow symbol 503 on the stacking tray 813. By arranging a box 501 at this slip off position, the sheet bundle Sb is input into the box 501. Also, as described above, because the bundle detection sensor 815 is attached to the stacking stopper 814, it is not possible for the bundle detection sensor 815 to detect the existence of the sheet bundle Sb stacked on the stacking tray 813 in this state. Also, when the stacking mode detection sensor 816 detects a state where the stacking stopper 814 is rotated to the predetermined position in the counterclockwise direction (the state in FIG. 5B), the stacking mode detection sensor 816 determines that the stacking through mode is set and notifies the CPU 301 of that.

[Configuration of Operation Unit 203]

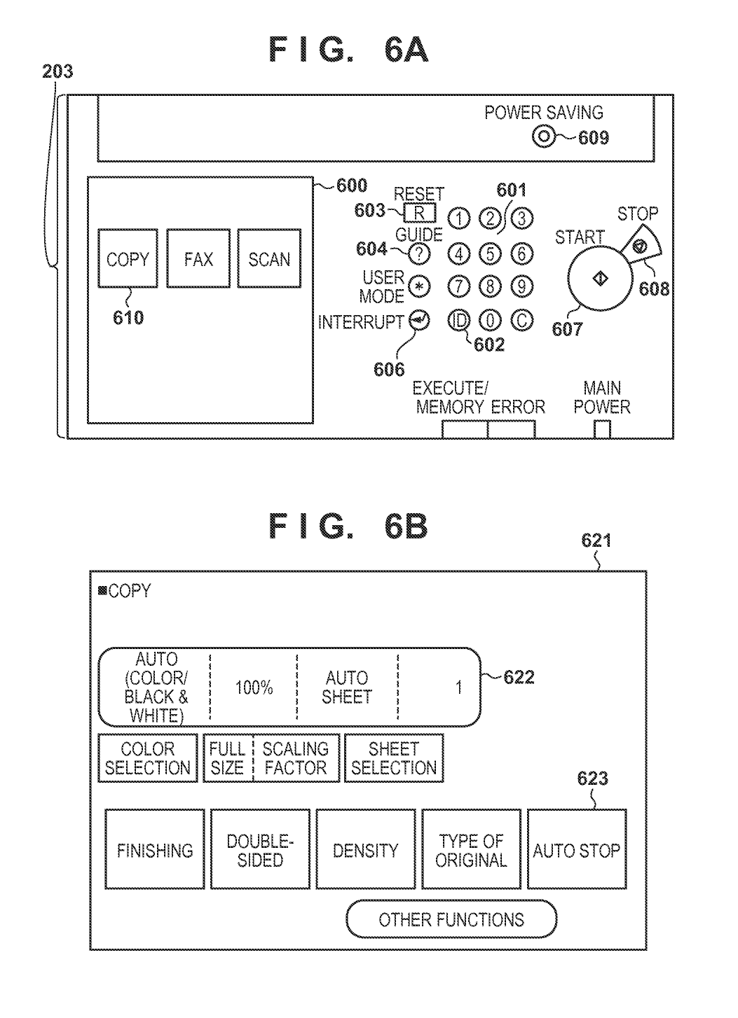

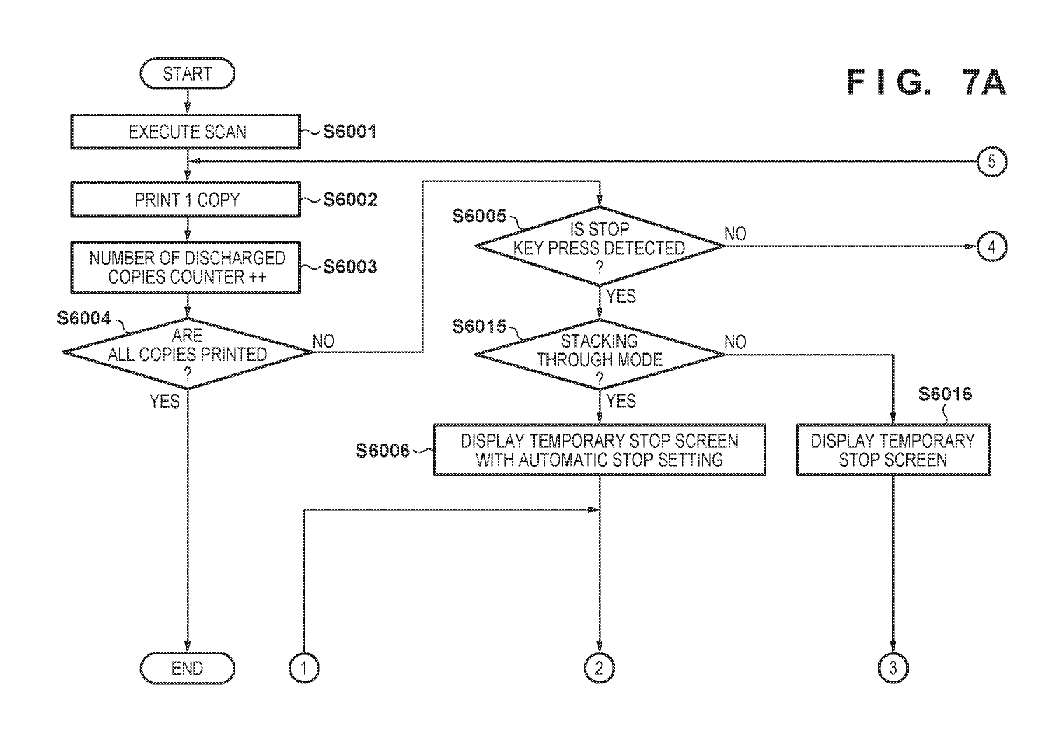

Next, an explanation is given for an example configuration of the operation unit 203 using FIG. 6A.

An LCD touch panel 600 comprises of a display screen for displaying various information including a GUI, and comprises of a touch panel for detecting a touch position on the display screen.

A numeric keypad 601 is hard keys operated by a user to perform numeric value input, and by which it is possible to input a number of print copies, for example. An ID button 602 is a button used when a department number and a password mode are inputted in a case where the apparatus is managed by department. A reset button 603 is a button used to reset setting content. A guide button 604 is a button used for displaying an explanation screen for each mode. An interrupt button 606 is a button used for performing an interrupt copy. A copy start button 607 is a button used to cause the above described copy function to be executed. A stop button 608 is a button for causing a temporary stoppage of a currently executing copy operation. By pressing a power saving SW 609, a backlight of the LCD touch panel 600 is turned off, and the apparatus transitions to power saving state.

A copy icon 610 is an icon that is touched in order to perform a setting for the copy function, and that is displayed on the LCD touch panel 600 as shown in FIG. 6A. When the user touches the copy icon 610 on the LCD touch panel 600, a GUI 621 shown in FIG. 6B is displayed on the LCD touch panel 600. When the user operates the numeric keypad 601 and inputs a number of copies in a state in which the GUI 621 is displayed, the inputted number of copies is displayed in a number of copies display unit 622 in the GUI 621.

[Copy Print Operation Flow]

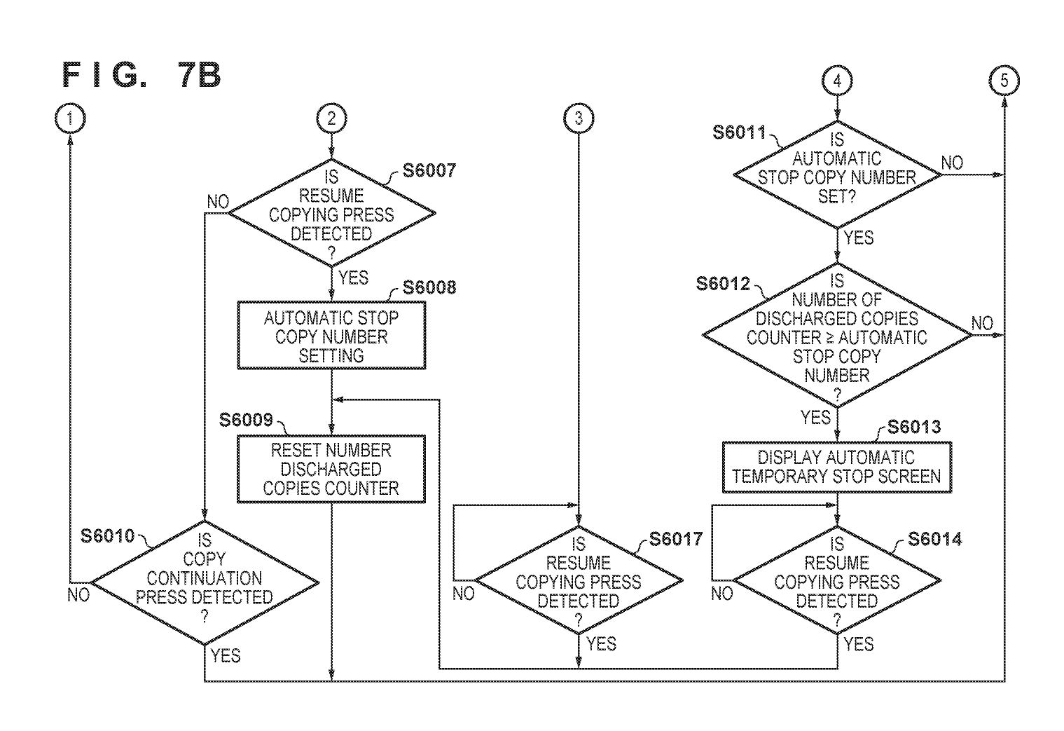

Next, explanation is given using the flowcharts of FIGS. 7A and 7B for operation of the image forming apparatus 101 in a case where printing (copy) of a plurality of copies is executed. Note that below explanation is given for a case in which copying is performed for a plurality of copies, but similar processing is performed even in a case where printing is performed for a plurality of copies based on a print job that is simply transmitted from the computer terminal 102.

<Step S6001>

When a user inputs a scan instruction by operating the operation unit 203, or a scan instruction is received from the computer terminal 102, the CPU 301 controls the scanner unit 201 and causes the scanner unit 201 to perform a read operation on a sheet bundle that is a target of a scan (may be a single sheet but below is assumed to be a sheet bundle). Because a reading result (scan image) for each sheet is output from the scanner unit 201 by this, the CPU 301 controls the image processor 303 to perform appropriate image processing on the scan image and store to the HDD 305.

<Step S6002>

The CPU 301 reads an image that is the target of the printing from the HDD 305 by controlling the image processor 303, applies appropriate image processing to the read image, and sends to the printer unit 202, thereby causing the printer unit 202 to perform the print processing of one copy (copies=1). With this, the printer unit 202 discharges a sheet bundle of one copy to the stacking tray 813 by performing print processing for one copy.

<Step S6003>

The CPU 301 increments, by 1, the value of a variable K which is a number of discharged copies counter when the printer unit 202 performs print processing for one copy and the sheet bundle for the one copy is caused to be discharged to the stacking tray 813. The value of this variable K is initialized to 0 upon initiation of the processing in accordance with the flowcharts of FIGS. 7A and 7B (at the least before initiation of the processing of step S6002 it is initialized to 0).

<Step S6004>

The CPU 301 determines whether or not printing for a set number of copies (for example, the number of copies that a user sets by operating the operation unit 203, or the number of copies set on the computer terminal 102 side) has completed. If the result of this determination is that printing of the set number of copies has completed, the processing in accordance with the flowcharts of FIGS. 7A and 7B completes, and if printing of the set number of copies has not completed yet, the processing proceeds to step S6005.

<Step S6005>

The CPU 301 determines whether or not the stop button 608 is pressed. If the result of the determination is that the stop button 608 is pressed, the processing proceeds to step S6015, and if it was not pressed the processing proceeds to step S6011.

<Step S6015>

The CPU 301 first controls the printer unit 202 to interrupt printing. Next, the CPU 301 determines whether a notification from the stacking mode detection sensor 816 is for the normal stacking mode or for the stacking through mode. If the result of this determination is that the notification from the stacking mode detection sensor 816 is for the normal stacking mode, the processing proceeds to step S6016, and if it is for the stacking through mode, the processing proceeds to step S6006.

<Step S6016>

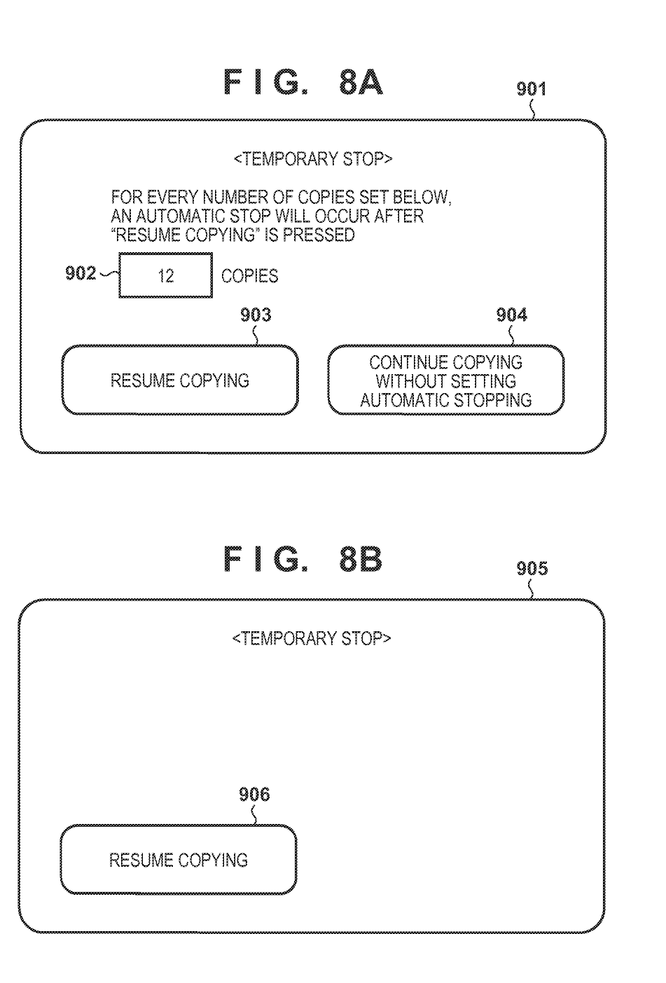

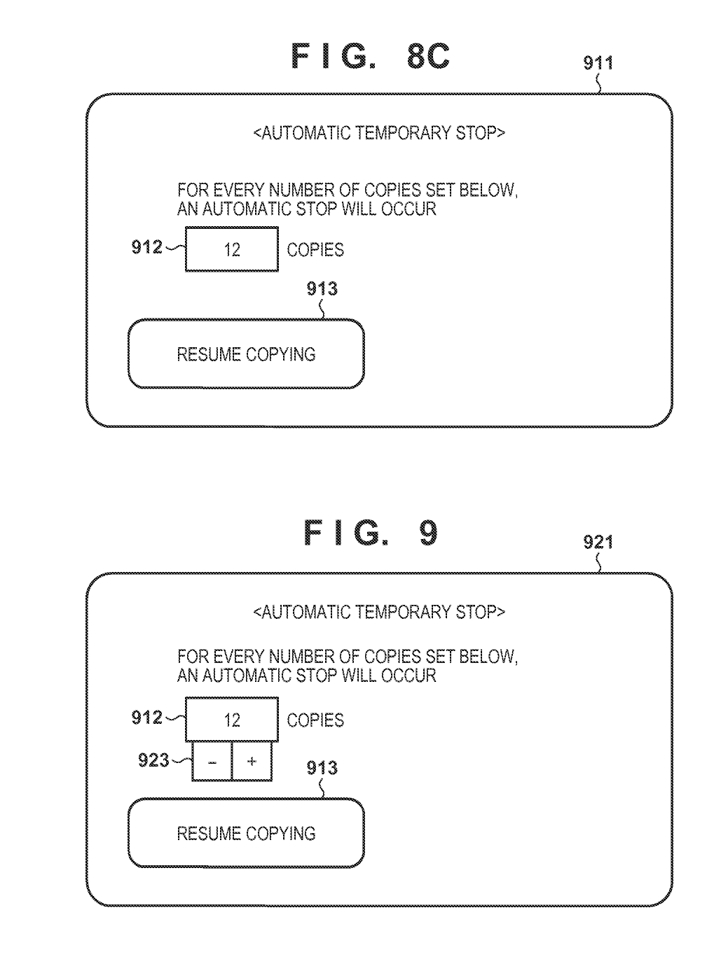

The CPU 301 displays a GUI 905 illustrated in FIG. 8B on the LCD touch panel 600.

<Step S6017>

The CPU 301 determines whether or not a resume copying button 906 in the GUI 905 is touched. If the result of the determination is that it is touched, the processing proceeds to step S6009, and if it is not touched the processing waits in step S6017.

<Step S6009>

The CPU 301 initializes the value of the variable K to 0. Then, after step S6009, the processing proceeds to step S6002, and the printer unit 202 is caused to resume printing on the next copy.

<Step S6006>

The CPU 301 displays a GUI 901 illustrated in FIG. 8A on the LCD touch panel 600. In a region 902, the current value of the variable K, i.e. the number of copies that the printer unit 202 discharged until operation was interrupted first (step S6006 of the first time), or the number of copies that the printer unit 202 discharged between when the operation was interrupted the previous time to the interruption this time (step S6006 of the second time or later) is displayed.

<Step S6007>

The CPU 301 determines whether or not the user touched a resume copying button 903. If the result of this determination is that the resume copying button 903 is touched, the processing proceeds to step S6008, and if the resume copying button 903 is not touched, the processing proceeds to step S6010.

For example, the user causes the printing to be interrupted by first pressing the stop button 608 in order to arrange the box 501 so as to receive/stop sheet bundles that slip off from the stacking tray 813 in the direction as is illustrated by the arrow symbol 503 as is illustrated in FIG. 5B. Then, when the user finishes arranging the box 501 during the interruption of the printing, the user touches the resume copying button 903 so as to resume the printing.

<Step S6008>

The CPU 301 sets a numerical value displayed in the region 902 to a value of a variable C which indicates an automatic stop copy number. Note that the value of the variable C is initialized to 0 upon initiation of the processing according to the flowcharts of FIGS. 7A and 7B. Then, the processing proceeds to step S6009.

<Step S6010>

The CPU 301 determines whether or not the user touched a copy continuation button 904. If the result of this determination is that the copy continuation button 904 is touched, the processing proceeds to step S6002, and if the copy continuation button 904 is not touched, the processing proceeds to step S6007. The copy continuation button 904 is used for resumption of printing when the printing is temporarily stopped with the objective of confirming the result of the printed materials, for example.

<Step S6011>

The CPU 301 determines whether or not the value of the variable C is 0, i.e. whether or not the automatic stop copy number is designated. If the result of this determination is that C=0, i.e. that the automatic stop copy number is not set, the processing proceeds to step S6002, and if C>0, i.e. the automatic stop copy number is set, the processing proceeds to step S6012.

<Step S6012>

The CPU 301 determines whether or not a condition that the value of the variable K≧the value of the variable C is satisfied. In other words, it is determined whether or not the number discharged copies from when the automatic stop copy number was set and the printing was caused to resume reaches the automatic stop copy number.

If the result of the determination is that this condition is satisfied (the number discharged copies from when the automatic stop copy number was set and the printing was caused to resume reaches the automatic stop copy number), the processing proceeds to step S6013. On the other hand, if the result of the determination is that this condition is not satisfied (the number discharged copies from when the automatic stop copy number was set and the printing was caused to resume does not reach the automatic stop copy number), the processing proceeds to step S6002.

<Step S6013>

The CPU 301 displays a GUI 911 illustrated in FIG. 8C on the LCD touch panel 600. In a region 912, the value of the variable C, i.e. the automatic stop copy number is displayed.

<Step S6014>

The CPU 301 determines whether or not a resume copying button 913 is touched. If the result of this determination is that the resume copying button 913 is touched, the processing proceeds to step S6009, and if the resume copying button 913 is not touched, the processing waits in step S6014.

Note that the configuration of the image forming apparatus 101 explained in the present embodiment resolves to a configuration having components shown below.
a printing unit for performing printing of a plurality of copies and discharging sheets of each copy
a first control unit for causing an operation to be interrupted whenever during an operation of a printing unit an instruction to interrupt the operation is input by a user, and causing the interrupted operation to resume when a resume instruction is input by the user
an acquisition unit for acquiring a number of copies discharged until the operation of the printing unit is interrupted based on an interrupt instruction
a second control unit for causing an operation of the printing unit to be interrupted whenever the number of copies discharged from when an interrupted operation of the printing unit is resumed based on a resume instruction reaches the number of copies acquired by the acquisition unit, and causing the interrupted operation to resume when a resume instruction is inputted by a user

In the present embodiment, the number of copies that the acquisition unit acquires is the number of copies that the printing unit discharged until operation was first interrupted, or the number of copies discharged from when the printing unit interrupted operation the previous time to the interruption this time.

Any configuration may be used if it resolves to this kind of configuration. For example, configuration may also be taken such that step S6009 is omitted, the number of copies that are actually discharged are counted by the variable K without initializing the value of the variable K to 0, the above described operation is caused to be interrupted whenever the counted number of copies reaches a multiple of “the number of copies discharged until the printing unit first interrupts the operation, or the number of copies discharged from when the printing unit interrupts the operation the previous time to the interruption this time”, and when an instruction to resume the interrupted operation is input, the interrupted operation is caused to resume.

### Second Embodiment

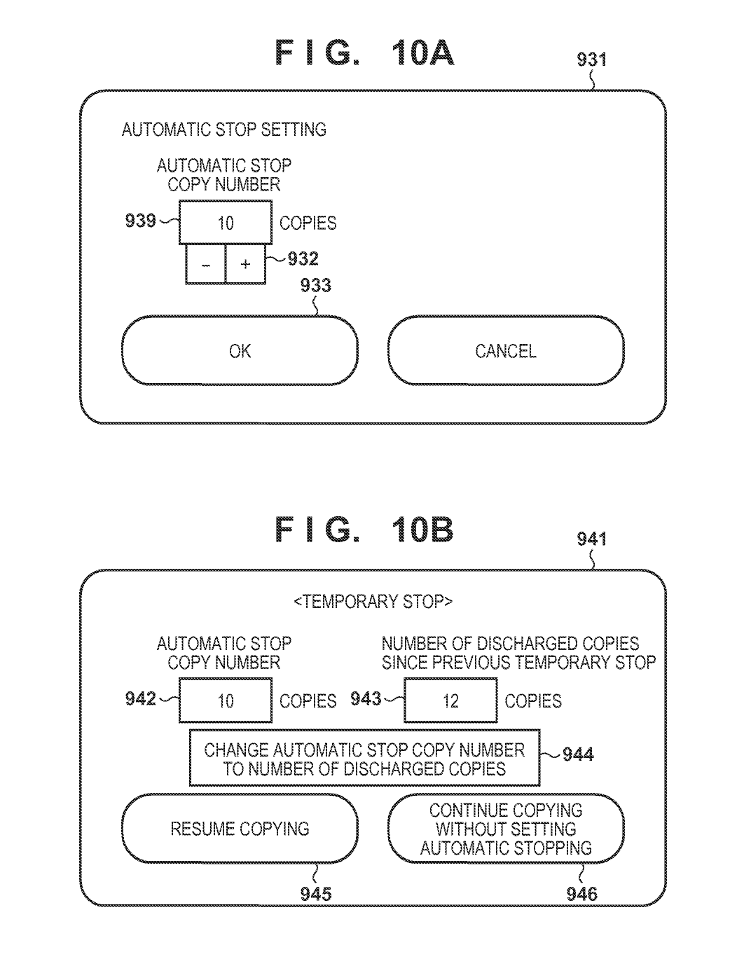

In step S6013, in place of the GUI 911 of FIG. 8C, a GUI 921 illustrated in FIG. 9 may be displayed on the LCD touch panel 600. Because buttons 923 cause the automatic stop copy number to increase/decrease (adjust) upon being touched by a user, configuration may also be taken such that the automatic stop copy number is caused to increase by 1 every time a “+” button is touched, and the automatic stop copy number is caused to decrease by 1 every time when a “−” button is touched, for example. The automatic stop copy number after the adjustment is displayed in the region 912. Also, the automatic stop copy number after the adjustment is set in the variable C.

### Third Embodiment

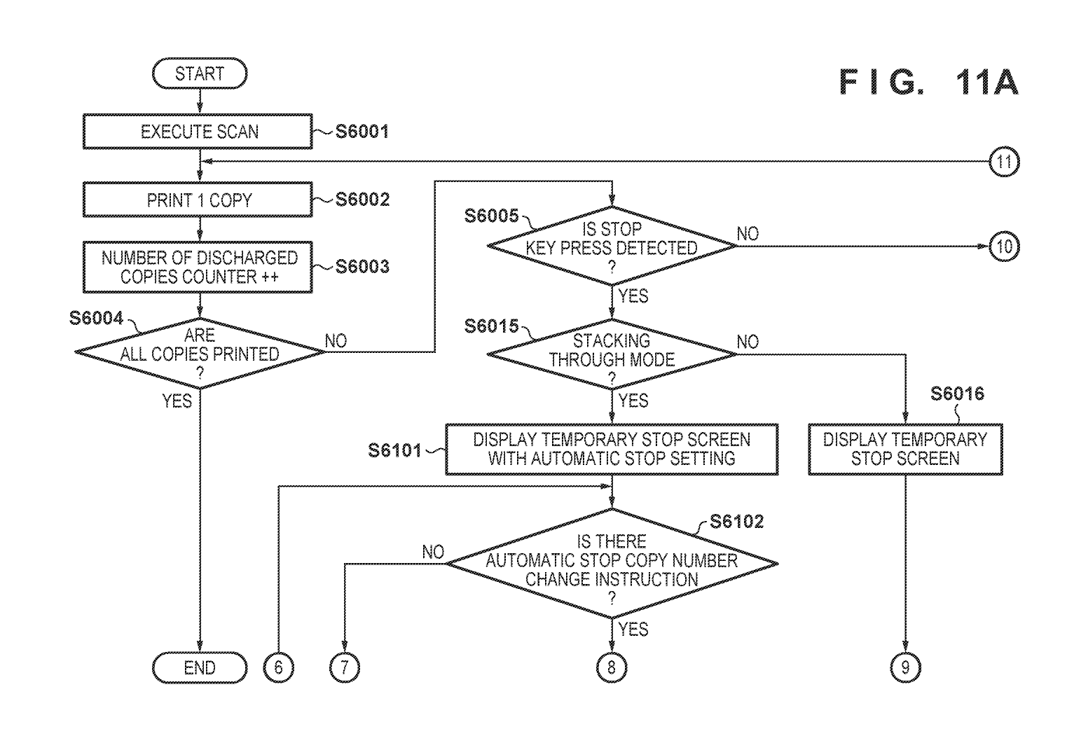

The automatic stop copy number may be set in advance. For example, in the GUI 621 of FIG. 6B, when a user touches an automatic stop button 623, a GUI 931 illustrated in FIG. 10A is displayed on the LCD touch panel 600.

Buttons 932 cause the automatic stop copy number to increase/decrease (adjust) upon being touched by a user, configuration may also be taken such that the automatic stop copy number is caused to increase by 1 every time a “+” button is touched, and the automatic stop copy number is caused to decrease by 1 every time when a “−” button is touched, for example. The automatic stop copy number after the adjustment is displayed in a region 939. Note that in a case where a numerical value is displayed for the first time in the region 939 such as when the GUI 931 is displayed for the first time, an appropriate initial value may be employed for the numerical value. Then, when the user touches an OK button 933, the numerical value displayed on the region 939 at that point in time is set as the automatic stop copy number. In other words, the numerical value displayed in the region 939 at that point in time is assigned to the value of the variable C.

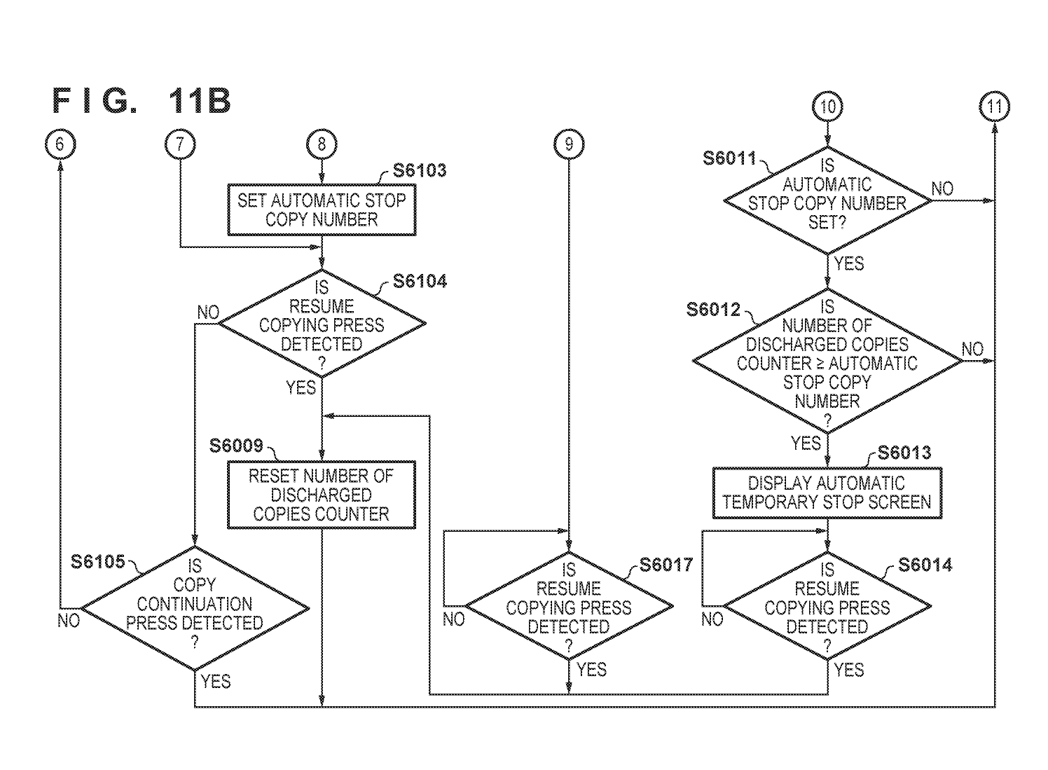

However, it can be considered that it is difficult for a user to know in advance the number of copies of sheets that will fit into the box that is used, and in spite of the fact that the automatic stop copy number is set in advance upon initiation of a copy, the user will perform a temporary stoppage manually. In consideration of such a case, in the present embodiment the image forming apparatus 101 executes processing in accordance with the flowcharts of FIGS. 11A and 11B. Below, explanation is given predominantly for differences with the first embodiment, and to the extent that something is not touched upon particularly below, it is similar to in the first embodiment. Also, in FIGS. 11A and 11B, the same reference numerals are added for processing steps that are the same as processing steps illustrated in FIGS. 7A and 7B, and explanation corresponding to these processing steps is abbreviated.

<Step S6101>

The CPU 301 displays a GUI 941 illustrated in FIG. 10B on the LCD touch panel 600. A region 942 is a region for displaying the automatic stop copy number, and the value of the variable C is displayed. Note that in a case where setting of the automatic stop copy number is not performed using the GUI 931 illustrated in FIG. 10A, the value of the variable C is “0”, and in that case nothing is displayed in the region 942. A region 943 is a region for displaying a current value of the variable K.

A button 944 is a button for setting the value of the variable K to the value of the variable C, and the value of the variable K is set to the value of the variable C when a user touches the button 944. Then, in the region 942 the same numerical value as the numerical value that is displayed in the region 943 is displayed. A resume copying button 945 and a copy continuation button 946 have the same functions as the resume copying button 903 and the copy continuation button 904 of FIG. 8A respectively.

<Step S6102>

The CPU 301 determines whether or not the button 944 in the GUI 941 of FIG. 10B is touched. If the result of the determination is that it is touched, the processing proceeds to step S6103, and if it is not touched the processing proceeds to step S6104.

<Step S6103>

The CPU 301 sets the value of the variable K to the value of the variable C. Also, the CPU 301 displays in the region 942 the same numerical value as the numerical value that is displayed in the region 943.

<Step S6104>

The CPU 301 determines whether or not the user touched the resume copying button 945. If the result of this determination is that the resume copying button 945 is touched, the processing proceeds to step S6009, and if the resume copying button 945 is not touched, the processing proceeds to step S6105.

<Step S6105>

The CPU 301 determines whether or not the user touched the copy continuation button 946. If the result of this determination is that the copy continuation button 946 is touched, the processing proceeds to step S6002, and if the copy continuation button 946 is not touched, the processing proceeds to step S6102.

In the present embodiment, the first control unit explained at the end of the first embodiment operates as something that updates a value set in advance as the automatic stop copy number to the number of copies that the printing unit discharged until operation is first interrupted, or to the number of copies that the printing unit discharged from when the operation was previously interrupted to the interruption this time.

Note that, in the first and second embodiments, printing is assumed to be in units of “copies”, but it is not limited to these units and may be in “sheets”, for example.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-231047, filed Nov. 13, 2014 which is hereby incorporated by reference herein in its entirety.

What is claimed is:

1. A print apparatus, comprising:
a print unit configured to print an image on a sheet;
an operation unit configured to accept an instruction from a user;
a control unit configured to cause printing by the print unit to stop based on acceptance of a print stop instruction via the operation unit, and to cause printing by the print unit to resume based on acceptance of a print resume instruction via the operation unit; and
an acquisition unit configured to acquire a number of copies printed from when the print unit started printing to when printing is stopped by the control unit, wherein
the control unit, after causing printing by the print unit to resume, causes printing by the print unit to stop based on the number of copies that the acquisition unit acquired.

2. The print apparatus according to claim 1, further comprising a setting unit configured to set whether or not to cause printing to stop based on the number of copies that the acquisition unit acquired.

3. The print apparatus according to claim 1, further comprising a display unit configured to display the number of copies that the acquisition unit acquired.

4. The print apparatus according to claim 3, wherein the display unit displays the number of copies that the acquisition unit acquired based on acceptance of the print stop instruction.

5. The print apparatus according to claim 4, further comprising:
a discharge unit configured to discharge a sheet on which an image is printed by the print unit; and
a stopper configured to receive and stop a sheet discharged by the discharge unit,
wherein
the display unit, when the print stop instruction is accepted, does not display the number of copies that the acquisition unit acquired if the stopper is being used, and does display the number of copies that the acquisition unit acquired if the stopper is not being used.

6. The print apparatus according to claim 3, further comprising
a changing unit configured to change the number of copies that the display unit displays, wherein
the control unit, in a case where the number of copies is changed by the changing unit, causes, after printing by the print unit is caused to resume, printing by the print unit to stop based on the number of copies after the change by the changing unit.

7. The print apparatus according to claim 1, further comprising:
a reading unit configured to read an image on an original, wherein
the print unit prints the image read by the reading unit.

8. A method of controlling a print apparatus that comprises
a print unit configured to print an image on a sheet and
an operation unit configured to accept an instruction from a user, the method comprising:
causing printing by the print unit to stop based on acceptance of a print stop instruction via the operation unit, and causing printing by the print unit to resume based on acceptance of a print resume instruction via the operation unit; and
acquiring a number of copies printed from when the print unit started printing to when printing is caused to stop, wherein
after printing by the print unit is caused to resume, printing by the print unit is caused to stop based on the acquired number of copies.

9. A non-transitory computer-readable storage medium storing a computer program for causing a computer of a print apparatus, the print apparatus comprises
a print unit configured to print an image on a sheet and
an operation unit configured to accept an instruction from a user, to function as
a control unit configured to cause printing by the print unit to stop based on acceptance of a print stop instruction via the operation unit, and to cause printing by the print unit to resume based on acceptance of a print resume instruction via the operation unit; and
an acquisition unit configured to acquire a number of copies printed from when the print unit started printing to when printing is stopped by the control unit, wherein
the control unit, after causing printing by the print unit to resume, causes printing by the print unit to stop based on the number of copies that the acquisition unit acquired.
